(19) United States
(12) Patent Application Publication
(10) Pub. No.: US 2025/0303765 A1
(43) Pub. Date: Oct. 2, 2025

(54) LIQUID DISPENSING DEVICE AND LIQUID DISPENSING UNIT

(71) Applicant: SEIKO EPSON CORPORATION, Tokyo (JP)

(72) Inventors: Koichi KASHU, Shiojiri (JP); Kyo HORIE, Okaya (JP); Toru MATSUYAMA, Matsumoto (JP)

(21) Appl. No.: 19/089,062

(22) Filed: Mar. 25, 2025

(30) Foreign Application Priority Data
Mar. 27, 2024 (JP) 2024-050677

(51) Int. Cl. B41J 29/377; B41J 2/045; B41J 2/14; B41J 25/00

(52) U.S. Cl. CPC B41J 29/377; B41J 2/04541; B41J 2/04581; B41J 2/14233; B41J 25/001

(57) ABSTRACT

A liquid dispensing unit including a plurality of driving elements driven by a drive signal and for dispensing a liquid in response to driving of the plurality of driving elements, the liquid dispensing unit includes: a substrate; a drive signal generation circuit disposed on the substrate and configured to generate the drive signal; and a heat sink fixed to the substrate. The heat sink includes a main body portion formed of copper or aluminum, and the main body portion is coated with graphene.

The present application is based on, and claims priority from JP Application Serial Number 2024-050677, filed Mar. 27, 2024, the disclosure of which is hereby incorporated by reference herein in its entirety.

### BACKGROUND

### 1. Technical Field

The present disclosure relates to a liquid dispensing device and a liquid dispensing unit.

### 2. Related Art

It is known a liquid dispensing device that includes a liquid dispensing unit that dispenses a liquid such as an ink in response to driving by a drive signal. For example, JP-A-2022-117049 discloses a liquid dispensing device including a drive signal generation circuit disposed on a substrate, and a liquid dispensing unit that dispenses an ink in response to driving by a drive signal generated in the drive signal generation circuit, and which dissipates heat generated in the drive signal generation circuit from the substrate.

The drive signal for driving the liquid dispensing unit is a large amplitude signal, and an amount of heat generated in the drive signal generation circuit when generating the drive signal is large. Therefore, when the heat generated in the drive signal generation circuit is dissipated from the substrate as in the related art, the amount of heat generated in the drive signal generation circuit can exceed the amount of heat dissipated from the substrate, causing a temperature of the drive signal generation circuit to increase. Further, when the temperature of the drive signal generation circuit increases, an operation of the drive signal generation circuit may be unstable.

### SUMMARY

In order to solve the above problems, a liquid dispensing unit according to the present disclosure is a liquid dispensing unit including a plurality of driving elements driven by a drive signal and for dispensing a liquid in response to driving of the plurality of driving elements, the liquid dispensing unit includes: a substrate; a drive signal generation circuit disposed on the substrate and configured to generate the drive signal; and a heat sink fixed to the substrate. The heat sink includes a main body portion formed of copper or aluminum, and the main body portion is coated with graphene.

In addition, liquid a dispensing device according to the present disclosure includes: a liquid dispensing unit including a plurality of driving elements driven by a drive signal and for dispensing a liquid in response to driving of the plurality of driving elements; and a drive signal generation unit configured to generate the drive signal. The drive signal generation unit includes a substrate, a drive signal generation circuit disposed on the substrate and configured to generate the drive signal, and a heat sink fixed to the substrate, the heat sink includes a main body portion formed of copper or aluminum, and the main body portion is coated with graphene.

### BRIEF DESCRIPTION OF THE DRAWINGS

FIG. 1 is a block diagram showing an example of a configuration of an inkjet printer 1 according to a first embodiment of the present disclosure.

FIG. 2 is a perspective view showing an example of a schematic internal structure of the inkjet printer 1.

FIG. 3 is a cross-sectional view showing an example of a structure of a dispensing portion D[m].

FIG. 4 is a block diagram showing an example of a configuration of a drive signal generation circuit 4.

FIG. 5 is a block diagram showing an example of a configuration of a liquid dispensing unit 3.

FIG. 6 is a timing chart showing an example of signals supplied to the liquid dispensing unit 3.

FIG. 7 is a diagram showing an example of an individual designation signal Sd[m].

FIG. 8 is a cross-sectional view showing an example of a structure of a drive signal generation unit 5.

FIG. 9 is a cross-sectional view showing an example of a structure of a drive signal generation unit 5W according to an example in the related art.

FIG. 10 is a diagram showing an outline of the drive signal generation unit 5 and the drive signal generation unit 5W.

FIG. 11 is a cross-sectional view showing an example of a structure of a drive signal generation unit 5B according to a second embodiment of the present disclosure.

FIG. 12 is a diagram showing an example of a composition of a reaction liquid.

FIG. 13 is a cross-sectional view showing an example of a structure of a drive signal generation unit 5C according to a third embodiment of the present disclosure.

FIG. 14 is a block diagram showing an example of a configuration of an inkjet printer 1D according to Modification 1 of the present disclosure.

FIG. 15 is a cross-sectional view showing an example of a structure of the drive signal generation unit 5B according to Modification 2 of the present disclosure.

FIG. 16 is a cross-sectional view showing an example of a structure of the drive signal generation unit 5C according to Modification 2 of the present disclosure.

### DESCRIPTION OF EMBODIMENTS

An aspect for implementing the present disclosure will hereinafter be described with reference to the drawings. In the respective drawings, dimensions and scales of the respective parts are made different from real ones as appropriate. The following embodiment is preferable specific example of the present disclosure and therefore various technically preferable limitations are imposed thereon, however, the scope of the present disclosure is not limited to the embodiment unless there is a description that the present disclosure is limited thereto in particular in the following description.

### A. First Embodiment

In a first embodiment, a liquid dispensing device will be described using an inkjet printer 1 that dispenses an ink to form an image on a recording paper PP as an example.

### A.1. Overview of Inkjet Printer

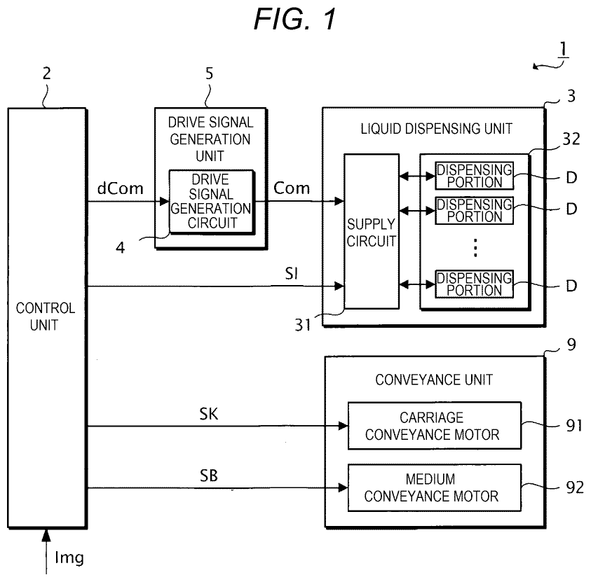

An example of the configuration of the inkjet printer 1 according to the first embodiment will be described below with reference to FIGS. 1 to 3.

FIG. 1 is a functional block diagram showing an example of the configuration of the inkjet printer 1.

As shown in FIG. 1, print data Img indicating an image to be formed by the inkjet printer 1 is supplied to the inkjet printer 1 from a personal computer or a host computer such as a digital camera. The inkjet printer 1 executes printing processing of forming, on the recording paper PP, an image indicated by the print data Img supplied from the host computer.

As shown in FIG. 1, the inkjet printer 1 includes a control unit 2 that controls each unit of the inkjet printer 1, a liquid dispensing unit 3 provided with dispensing portions D that dispense an ink onto recording paper PP, the drive signal generation unit 5 provided with the drive signal generation circuit 4 that generates a drive signal Com for driving the dispensing portions D, and a conveyance unit 9 for conveying the liquid dispensing unit 3 and the recording paper PP.

In the first embodiment, the inkjet printer 1 is an example of a “liquid dispensing device”, the ink is an example of a “liquid”, and the recording paper PP is an example of a “medium”.

In the first embodiment, it is assumed that the inkjet printer 1 includes one or a plurality of liquid dispensing units 3 and one or a plurality of drive signal generation units 5 that correspond one-to-one to the one or a plurality of liquid dispensing units 3. Specifically, in the first embodiment, it is assumed that the inkjet printer 1 includes four liquid dispensing units 3 and four drive signal generation units 5 that correspond one-to-one to the four liquid dispensing units 3. However, in the following description, for convenience of description, as shown in FIG. 1, one liquid dispensing unit 3 of the four liquid dispensing units 3 and one drive signal generation unit 5 of the four drive signal generation units 5 provided corresponding to the one liquid dispensing unit 3 may be focused on.

The control unit 2 includes one or a plurality of central processing units (CPUs). However, the control unit 2 may include a programmable logic device such as a field-programmable gate array (FPGA) in place of or in addition to the CPU. The control unit 2 includes a memory. The memory includes one or both of a volatile memory such as a random access memory (RAM) and a nonvolatile memory such as a read only memory (ROM), an electrically erasable programmable read-only memory (EEPROM), or a programmable ROM (PROM).

The control unit 2 generates signals for controlling an operation of each unit of the inkjet printer 1, such as a designation signal SI, a waveform designation signal dCom, carriage conveyance control signal SK, and medium conveyance control signal SB.

Here, the waveform designation signal dCom is a digital signal that defines a waveform of the drive signal Com. The drive signal Com is an analog signal for driving the dispensing portion D. The designation signal SI is a digital signal for designating a type of an operation of the dispensing portion D. Specifically, the designation signal SI designates the type of operation of the dispensing portion D as to whether an ink is dispensed from the dispensing portion D by designating whether to supply the drive signal Com to the dispensing portion D. The carriage conveyance control signal SK and the medium conveyance control signal SB are signals for controlling the conveyance unit 9.

When printing processing is executed, the control unit 2 generates, based on the print data Img, signals for controlling the liquid dispensing unit 3, such as the designation signal SI. When the printing processing is executed, the control unit 2 generates signals for controlling the drive signal generation unit 5, such as the waveform designation signal dCom. When the printing processing is executed, the control unit 2 generates signals for controlling the conveyance unit 9, such as the carriage conveyance control signal SK and the medium conveyance control signal SB. Accordingly, in the printing processing, the control unit 2 controls the conveyance unit 9 to move the liquid dispensing unit 3 and the recording paper PP, adjusts whether to dispense the ink from the dispensing portion D, a dispense timing of the ink, and the like, and controls each unit of the inkjet printer 1 to form an image corresponding to the print data Img on the recording paper PP.

As shown in FIG. 1, the liquid dispensing unit 3 includes a supply circuit 31 and a liquid dispense head 32.

The liquid dispense head 32 includes M

dispensing portions D. Here, the value M is a natural number satisfying “M≥1”. Hereinafter, among the M dispensing portions D provided in the liquid dispense head 32, the m-th dispensing portion D may be referred to as a “dispensing portion D[m]”. Here, the variable m is a natural number satisfying “1≤m≤M”. Hereinafter, when a component, a signal, or the like of the inkjet printer 1 corresponds to the dispensing portion D[m] among the M dispensing portions D, a subscript [m] may be added to a symbol representing the component, the signal, or the like.

The supply circuit 31 switches whether to supply the drive signal Com to the dispensing portion D[m] based on the designation signal SI. Hereinafter, among the drive signals Com, the drive signal Com supplied to the dispensing portion D[m] may be referred to as a supply drive signal Vin[m].

As shown in FIG. 1, the conveyance unit 9 includes a carriage conveyance motor 91 and a medium conveyance motor 92.

The carriage conveyance motor 91 conveys a carriage 110 to be described below based on the carriage conveyance control signal SK.

The medium conveyance motor 92 conveys the recording paper PP based on the medium conveyance control signal SB.

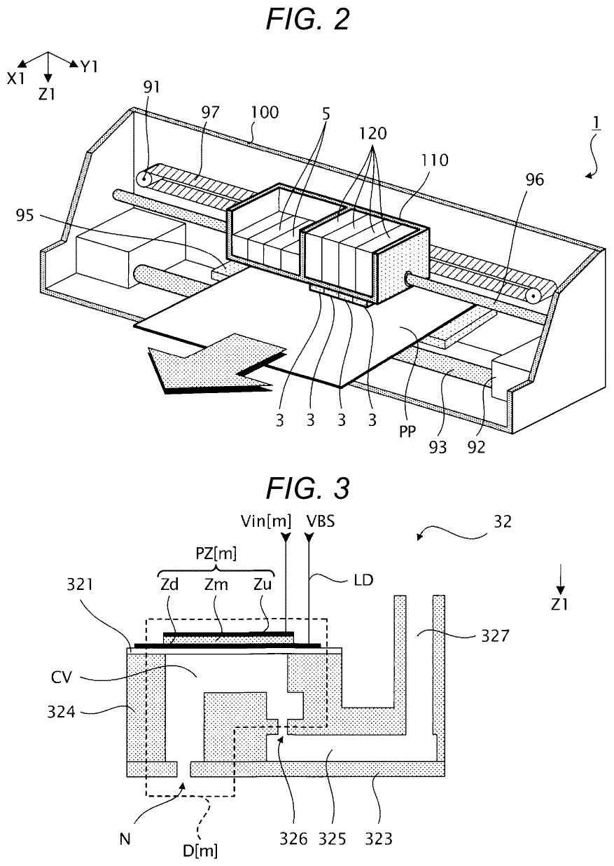

FIG. 2 is a perspective view showing an example of a schematic internal structure of the inkjet printer 1.

As shown in FIG. 2, in the first embodiment, a case in which the inkjet printer 1 is a serial printer is assumed. Specifically, when executing the printing processing, the inkjet printer 1 forms an image corresponding to the print data Img on the recording paper PP by dispensing an ink from the liquid dispensing unit 3 while conveying the recording paper PP in an X1 direction and moving the liquid dispensing unit 3 in a Y1 direction intersecting the X1 direction or a Y2 direction opposite to the Y1 direction.

Hereinafter, the X1 direction and an X2 direction opposite thereto are collectively referred to as an “X-axis direction”, the Y1 direction intersecting the X-axis direction and the Y2 direction opposite thereto are collectively referred to as a “Y-axis direction”, and a Z1 direction intersecting the X-axis direction and the Y-axis direction and a Z2 direction opposite to the Z1 direction are collectively referred to as a “Z-axis direction”. In the first embodiment, a case in which the X-axis direction, the Y-axis direction, and the Z-axis direction are orthogonal to one another will be described as an example. However, the present disclosure is not limited to such a mode. It is only necessary that the X-axis direction, the Y-axis direction, and the Z-axis direction intersect one another. In the first embodiment, the Z1 direction is a direction in which the ink is dispensed from the dispensing portion D.

As shown in FIG. 2, the inkjet printer 1

according to the first embodiment is provided with a housing 100 and the carriage 110 capable of reciprocating in the Y-axis direction in the housing 100. The carriage 110 includes four liquid dispensing units 3 and four drive signal generation units 5.

As shown in FIG. 2, in the first embodiment, it is assumed that the carriage 110 is equipped with four ink cartridges 120 that correspond one-to-one to four colors of the ink: cyan, magenta, yellow, and black. In the first embodiment, as described above, it is assumed that the carriage 110 is equipped with four liquid dispensing units 3 that correspond one-to-one to the four ink cartridges 120. Each dispensing portion D[m] is supplied with the ink from the ink cartridge 120 corresponding to the liquid dispensing unit 3 provided with the dispensing portion D[m]. Accordingly, each dispensing portion D[m] can fill the inside thereof with the supplied ink and dispense the ink filled in the dispensing portion D[m] from a nozzle N provided in the dispensing portion D[m]. The ink cartridge 120 may be provided outside the carriage 110.

As described above, the inkjet printer 1 according to the first embodiment includes the conveyance unit 9. As shown in FIG. 2, the conveyance unit 9 is provided with the carriage conveyance motor 91 for reciprocating the carriage 110 in the Y-axis direction, a carriage guide shaft 96 for supporting the carriage 110 so as to be able to reciprocate in the Y-axis direction, a belt 97 for conveying the carriage 110 in the Y-axis direction based on driving of the carriage conveyance motor 91, the medium conveyance motor 92 for conveying the recording paper PP in the X1 direction, a medium conveyance mechanism 93 for conveying the recording paper PP in the X1 direction by rotating based on driving of the medium conveyance motor 92, and a platen 95 provided in the Z1 direction of the carriage 110 and supporting the recording paper PP. Therefore, when the printing processing is executed, the conveyance unit 9 causes the carriage conveyance motor 91 to reciprocate the liquid dispensing unit 3 together with the carriage 110 in the Y-axis direction along the carriage guide shaft 96, and causes the medium conveyance motor 92 to convey the recording paper PP on the platen 95 in the X1 direction, thereby changing a relative position of the recording paper PP with respect to the liquid dispensing unit 3 and enabling the ink to land on the entire recording paper PP.

In the first embodiment, the carriage conveyance motor 91 is an example of a “motor”.

FIG. 3 is a schematic partial cross-sectional view of the liquid dispense head 32 when the liquid dispense head 32 is cut to include the dispensing portion D[m].

As shown in FIG. 3, the dispensing portion D[m] includes a piezoelectric element PZ[m], a cavity CV filled with the ink, the nozzle N communicating with the cavity CV, and a vibrating plate 321. The dispensing portion D[m] dispenses the ink inside the cavity CV from the nozzle N by the piezoelectric element PZ[m] being driven by the supply drive signal Vin[m]. The cavity CV is a space defined by a cavity plate 324, a nozzle plate 323 in which the nozzle N is formed, and the vibrating plate 321. The cavity CV communicates with a reservoir 325 via an ink supply port 326. The reservoir 325 communicates with the ink cartridge 120 corresponding to the dispensing portion D[m] via an ink intake port 327. The piezoelectric element PZ[m] includes an upper electrode Zu[m], a lower electrode Zd[m], and a piezoelectric body Zm[m] provided between the upper electrode Zu[m] and the lower electrode Zd[m]. The lower electrode Zd[m] is electrically coupled to a power supply line Ld that is set to a predetermined potential VBS. Further, when the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction or the Z2 direction according to the applied voltage, and as a result, the piezoelectric element PZ[m] vibrates. The lower electrode Zd[m] is bonded to the vibrating plate 321. Therefore, when the piezoelectric element PZ[m] is driven by the supply drive signal Vin[m] and vibrates, the vibrating plate 321 also vibrates. Further, a volume of the cavity CV and a pressure in the cavity CV change due to the vibration of the vibrating plate 321, and the ink filled in the cavity CV is dispensed from the nozzle N. A part of the ink dispensed from the nozzle N turns into mist and floats inside the housing 100.

In the first embodiment, the piezoelectric element PZ[m] is an example of a “driving element”.

### A. 2. Configuration of Drive Signal Generation Circuit 4

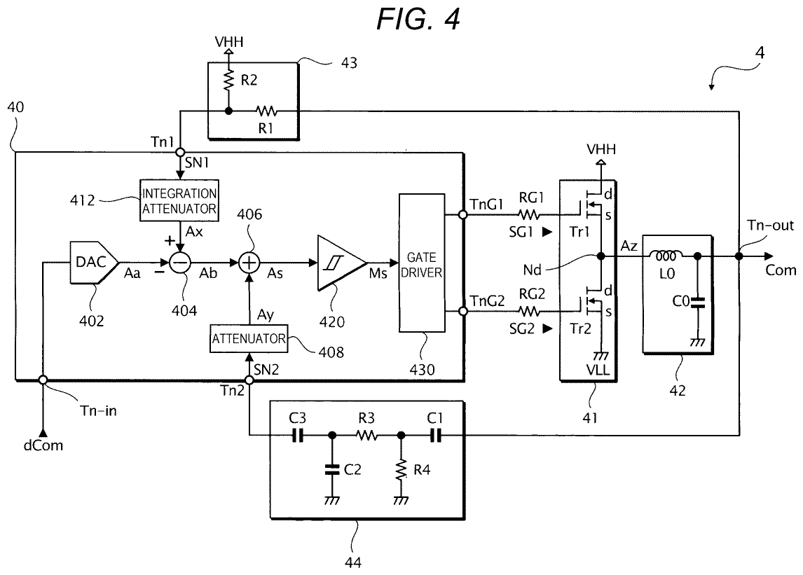

Hereinafter, an example of the configuration of the drive signal generation circuit 4 provided in the drive signal generation unit 5 will be described with reference to FIG. 4.

FIG. 4 is a diagram showing an example of a circuit configuration of the drive signal generation circuit 4.

As shown in FIG. 4, the drive signal generation circuit 4 includes an integrated circuit 40, an amplifier circuit 41, a smoothing circuit 42, a pull-up circuit 43, and a filter circuit 44, and generates the drive signal Com based on the waveform designation signal dCom.

The integrated circuit 40 is, for example, a large scale integration (LSI), and generates a gate signal SG1 and a gate signal SG2 based on the waveform designation signal dCom. Here, the gate signal SG1 is an example of a “first control signal”, and the gate signal SG2 is an example of a “second control signal”.

The integrated circuit 40 includes an analog conversion circuit 402, a subtractor 404, an adder 406, an attenuator 408, an integration attenuator 412, a comparator 420, and a gate driver 430.

The analog conversion circuit 402 is a digital to analog converter (DAC), and converts the digital waveform designation signal dCom into an analog signal Aa. A voltage amplitude of the signal Aa is, for example, about 0 to 2 volts, and a voltage obtained by amplifying the voltage by about 20 times becomes the drive signal Com. That is, the signal Aa is a signal before amplification of the drive signal Com.

The integration attenuator 412 attenuates and integrates a signal SN1 input to a terminal Tn1 to be described later, and outputs a signal Ax.

The subtractor 404 outputs a signal Ab indicating a potential obtained by subtracting a potential of the signal Aa from a potential of the signal Ax.

The attenuator 408 outputs a signal Ay obtained by attenuating a high-frequency component of a signal SN2 input to a terminal Tn2 to be described later.

The adder 406 outputs a signal As indicating a potential obtained by adding a potential of the signal Ab and a potential of the signal Ay.

The comparator 420 outputs a modulation signal Ms obtained by pulse-modulating the signal As. Specifically, the comparator 420 outputs the modulation signal Ms that goes to a high level when the signal As is equal to or higher than a threshold voltage Vth1 when the signal As is at a voltage rise, and goes to a low level when the signal As is lower than a threshold voltage Vth2 when the signal As is at a voltage fall. The threshold voltage Vth1 and the threshold voltage Vth2 are set to have a relationship of “Vth1>Vth2”.

A power supply voltage of a circuit from the analog conversion circuit 402 to the comparator 420 is a low voltage such as 3.3 volts. In contrast, the drive signal Com has a large amplitude and may be more than 40 volts, for example. Therefore, in the integration attenuator 412, an amplitude range of the signal Ax is adjusted to an amplitude range of the signal in the circuit from the analog conversion circuit 402 to the comparator 420 by attenuating the signal SN1 having an amplitude corresponding to the drive signal Com.

In the first embodiment, a mode in which a digital signal is described as an example of the waveform designation signal dCom, and the waveform designation signal dCom may be any signal that defines a target value for generating the drive signal Com, and for example, the analog signal Aa may be used as the waveform designation signal dCom. When the signal Aa is the waveform designation signal dCom, the integrated circuit 40 may be formed without including the analog conversion circuit 402.

The gate driver 430 outputs the gate signal SG1 obtained by converting the modulation signal Ms into a specific amplitude to a terminal TnG1. The gate driver 430 outputs the gate signal SG2 obtained by converting a signal obtained by inverting a logic level of the modulation signal Ms into a specific amplitude to a terminal TnG2.

The amplifier circuit 41 includes, for example, a transistor Tr1 and a transistor Tr2, and generates an amplified signal Az, which is a signal obtained by amplifying the modulation signal Ms, based on the gate signal SG1 and the gate signal SG2 output from the integrated circuit 40. Here, the transistor Tr1 is an example of a “first transistor”, and the transistor Tr2 is an example of a “second transistor”. Hereinafter, the transistor Tr1 and the transistor Tr2 may be collectively referred to as a transistor Tr. In the first embodiment, as an example, it is assumed that the transistor Tr1 and the transistor Tr2 are N-channel field effect transistors, that is, field effect transistors (FETs).

As shown in FIG. 4, the gate signal SG1 output from the gate driver 430 is input to a gate electrode of the transistor Tr1 via the terminal TnG1 and a resistor RG1. The gate signal SG2 output from the gate driver 430 is input to a gate electrode of the transistor Tr2 via the terminal TnG2 and a resistor RG2. Logic levels of the gate signal SG1 and the gate signal SG2 are mutually exclusive.

Here, “mutually exclusive” means that a signal level of the gate signal SG1 supplied to a gate electrode of the transistor Tr1 and a signal level of the gate signal SG2 supplied to a gate electrode of the transistor Tr2 do not simultaneously become high level, in other words, the transistor Tr1 and the transistor Tr2 are not simultaneously turned on. The transistor Tr1 is turned on when the gate signal SG1 input to the gate electrode of the transistor Tr1 is at a high level, and is turned off when the gate signal SG1 input to the gate electrode of the transistor Tr1 is at a low level. The transistor Tr2 is turned on when the gate signal SG2 input to the gate electrode of the transistor Tr2 is at a high level, and is turned off when the gate signal SG2 input to the gate electrode of the transistor Tr2 is at a low level.

As shown in FIG. 4, a drain electrode of the transistor Tr1 is electrically coupled to a power supply line set to a power supply potential VHH, and a source electrode is electrically coupled to a node Nd. A source electrode of the transistor Tr2 is electrically coupled to a power supply line set to a reference potential VLL lower than the power supply potential VHH, and a drain electrode is electrically coupled to the node Nd. The reference potential VLL may be, for example, a ground potential, or may be a potential same as a potential VBS.

As described above, the transistor Tr1 is turned on when the gate signal SG1 supplied to the gate electrode is at a high level, and is turned off when the gate signal SG1 is at a low level. The transistor Tr2 is turned on when the gate signal SG2 supplied to the gate electrode is at a high level, and is turned off when the gate signal SG2 is at a low level. Therefore, the amplified signal Az obtained by amplifying the modulation signal Ms is output to the node Nd that electrically couples the source electrode of the transistor Tr1 and the drain electrode of the transistor Tr2.

The smoothing circuit 42 is a low pass filter (LPF), and smoothes the amplified signal Az to generate the drive signal Com. The smoothing circuit 42 includes an inductor L0 and a capacitor C0.

The inductor L0 has one end electrically coupled to the node Nd and the other end electrically coupled to an output terminal Tn-out. Here, the inductor L0 is an example of a “coil”.

One end of the capacitor C0 is electrically coupled to the output terminal In-out, and the other end is electrically coupled to the power supply line set to the reference potential VLL. The drive signal Com obtained by smoothing the amplified signal Az is output from the output terminal In-out.

The pull-up circuit 43 feeds back, to the terminal Tn1, the signal SN1 obtained by pulling up the drive signal Com output from the output terminal Tn-out. The pull-up circuit 43 includes a resistor R1 having one end electrically coupled to the output terminal In-out and the other end electrically coupled to the terminal Tn1, and a resistor R2 having one end electrically coupled to the terminal Tn1 and the other end electrically coupled to the power supply line set to the power supply potential VHH.

The filter circuit 44 is a band pass filter (BPF), and feeds back, to the terminal Tn2, the signal SN2 obtained by cutting a DC component from a frequency component of a predetermined band in the drive signal Com. The filter circuit 44 includes a resistor R3, a capacitor C1 having one end electrically coupled to the output terminal Tn-out and the other end electrically coupled to one end of the resistor R3, a resistor R4 having one end electrically coupled to one end of the resistor R3 and the other end electrically coupled to the power supply line set to the reference potential VLL, a capacitor C2 having one end electrically coupled to the other end of the resistor R3 and the other end electrically coupled to the power supply line set to the reference potential VLL, and a capacitor C3 having one end electrically coupled to the other end of the resistor R3 and the other end electrically coupled to the terminal Tn2. Among these, the capacitor C1 and the resistor R4 function as a high pass filter (HPF) that passes a high-frequency component equal to or higher than a cutoff frequency in the drive signal Com. The resistor R3 and the capacitor C2 function as a low pass filter (LPF) that passes a low frequency component equal to or lower than the cutoff frequency in the drive signal Com. In the first embodiment, in the filter circuit 44, the cutoff frequency of the HPF is set lower than the cutoff frequency of the LPF. Therefore, the filter circuit 44 passes frequency components in a predetermined band that is equal to or higher than the cutoff frequency of the HPF and equal to or lower than the cutoff frequency of the LPF in the drive signal Com. Since the filter circuit 44 includes the capacitor C3, the filter circuit 44 feeds back, to the terminal Tn2, a signal obtained by cutting a DC component from a signal of a frequency component in a predetermined band that passes through the HPF and the LPF in the drive signal Com.

In this way, the drive signal generation circuit 4 generates the drive signal Com by smoothing the amplified signal Az at the node Nd by the smoothing circuit 42. The drive signal Com is subjected to integration and subtraction by the integration attenuator 412 and then fed back to the subtractor 404. Therefore, self-oscillation occurs at a frequency determined by a delay in the smoothing circuit 42, a delay in the integration attenuator 412, and a feedback transfer function. However, since a delay amount of a feedback path via the terminal Tn1 is large, a frequency of the self-oscillation cannot be increased to the extent that accuracy of a waveform of the drive signal Com can be sufficiently secured only by the feedback via the terminal Tn1. In contrast, in the first embodiment, since a path for feeding back the high-frequency components of the drive signal Com via the terminal Tn2 is provided separately from the path via the terminal Tn1, a feedback delay in the entire drive signal generation circuit 4 can be reduced. That is, in the first embodiment, since the frequency of the signal As obtained by adding the signal Ay, which is the high-frequency component of the drive signal Com, to the signal Ab can be made higher than that in the case in which there is no path via the terminal Tn2, it is possible to sufficiently secure the accuracy of the drive signal Com.

In the first embodiment, it is assumed that a frequency component of 50 kHz or higher is included in the drive signal Com. As in the first embodiment, in a case in which the drive signal Com includes the frequency component of 50 kHz or higher, when the frequency of the modulation signal Ms is set to be lower than 1 MHz, an edge portion of the waveform of the drive signal Com becomes dull, and the accuracy of the waveform of the drive signal Com decreases. When the accuracy of the waveform of the drive signal Com decreases, accuracy of the ink dispensed from the dispensing portion D decreases, and image quality of the image formed by the inkjet printer 1 may decrease. Therefore, in order to generate the drive signal Com as a signal having a waveform that accurately reproduces the waveform designated by the waveform designation signal dCom, it is necessary to set the frequency of the modulation signal Ms to 1 MHZ or higher. That is, in order to generate the drive signal Com as a signal having a waveform that accurately reproduces the waveform designated by the waveform designation signal dCom, it is necessary to set an oscillation frequency of the self-oscillation of the drive signal generation circuit 4 and a drive frequency of the transistor Tr1 and the transistor Tr2 to 1 MHz or higher. Therefore, in the first embodiment, by setting the frequency of the modulation signal Ms to 1 MHz or higher, the frequencies of the gate signal SG1 and the gate signal SG2 are set to 1 MHz or higher, and the drive frequencies of the transistor Tr1 and the transistor Tr2 are set to 1 MHz or higher. Accordingly, the waveform of the drive signal Com can be a waveform that accurately reproduces the waveform designated by the waveform designation signal dCom, and a decrease in the accuracy of the ink dispensed from the dispensing portion D can be prevented.

On the other hand, when the frequency of the modulation signal Ms increases, switching loss in the transistor Tr1 and the transistor Tr2 increases. When the switching loss of the transistor Tr1 and the transistor Tr2 increases, power consumption of the drive signal generation circuit 4 increases, and a heat generation amount of the drive signal generation circuit 4 increases. From the viewpoint of reducing the switching loss in the transistor Tr, the drive frequency of the transistor Tr is preferably 8 MHz or lower, and more preferably 4 MHZ or lower. Therefore, in the first embodiment, by setting the frequency of the modulation signal Ms to 8 MHZ or lower, the frequencies of the gate signal SG1 and the gate signal SG2 are set to 8 MHz or lower, and the drive frequencies of the transistor Tr1 and the transistor Tr2 are set to 8 MHz or lower. Accordingly, according to the first embodiment, it is possible to achieve both improvement in waveform accuracy of the drive signal Com and power saving of the drive signal generation circuit 4.

### A.3. Configuration and Operation of Liquid Dispensing Unit 3

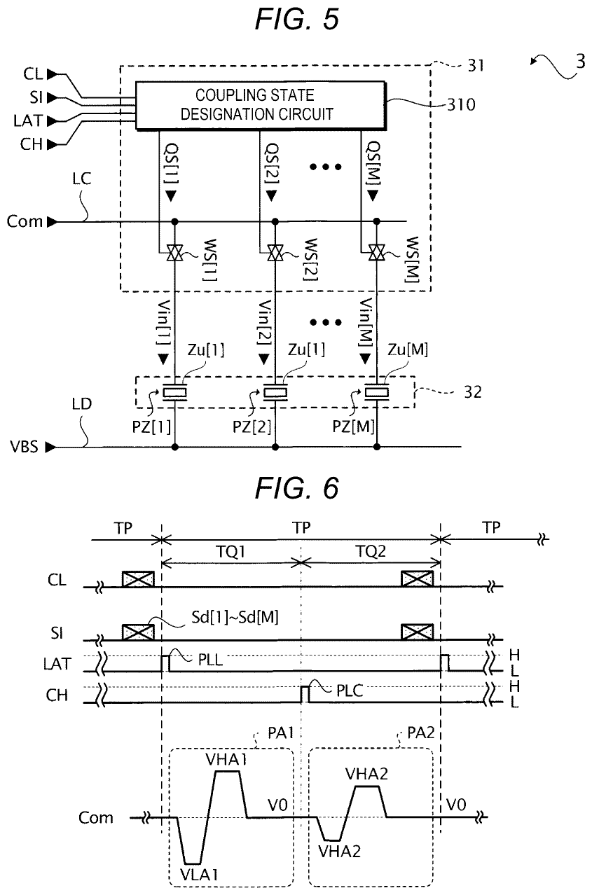

Hereinafter, an example of the configuration and operation of the liquid dispensing unit 3 will be described with reference to FIGS. 5 to 7.

FIG. 5 is a block diagram showing an example of the configuration of the liquid dispensing unit 3.

As shown in FIG. 5, the liquid dispensing unit 3 includes the supply circuit 31 and the liquid dispense head 32. The liquid dispensing unit 3 includes a wiring LC to which the drive signal Com is supplied from the drive signal generation unit 5.

As shown in FIG. 5, the supply circuit 31 includes M switches WS[1] to WS[M] that correspond one-to-one to the M dispensing portions D[1] to D[M], and a coupling state designation circuit 310 that designates a coupling state of each switch.

The coupling state designation circuit 310 generates a coupling state designation signal QS[m] for designating ON and OFF of the switch WS[m] based on at least a part of the designation signal SI, a latch signal LAT, and a change signal CH supplied from the control unit 2.

The switch WS[m] switches conduction and non-conduction between the wiring LC and the upper electrode Zu[m] of the piezoelectric element PZ[m] provided in the dispensing portion D[m] based on the coupling state designation signal QS[m]. In the first embodiment, the switch WS[m] is turned on when the coupling state designation signal QS[m] is at a high level, and turned off when the signal is at a low level. When the switch WS[m] is turned on, the drive signal Com supplied to the wiring LC is supplied to the upper electrode Zu[m] of the dispensing portion D[m] as the supply drive signal Vin[m].

FIG. 6 is a timing chart showing various signals such as the drive signal Com supplied to the liquid dispensing unit 3.

As shown in FIG. 6, when the inkjet printer 1 executes the printing processing, one or a plurality of unit periods TP are set as an operating period of the inkjet printer 1. In the first embodiment, the inkjet printer 1 can drive each dispensing portion D[m] for the printing processing in each unit period TP.

As shown in FIG. 6, the control unit 2 outputs the latch signal LAT having pulses PLL. Accordingly, the control unit 2 defines the unit period TP as a period from the rise of the pulse PLL to the rise of the next pulse PLL. The control unit 2 outputs the change signal CH having a pulse PLC in the unit period TP. The control unit 2 divides the unit period TP into a driving period TQ1 from the rise of the pulse PLL to the rise of the pulse PLC and a driving period TQ2 from the rise of the pulse PLC to the rise of the pulse PLL.

As shown in FIG. 6, the designation signal SI includes M individual designation signals Sd[1] to Sd[M] that correspond one-to-one to the M dispensing portions D[1] to D[M]. The individual designation signal Sd[m] designates a drive mode of the dispensing portion D[m] in each unit period TP when the inkjet printer 1 executes the printing processing. Prior to each unit period TP, the control unit 2 supplies the designation signal SI containing the M individual designation signals Sd[1] to Sd[M] to the coupling state designation circuit 310 in synchronization with a clock signal CL. Further, in the unit period TP, the coupling state designation circuit 310 generates the coupling state designation signal QS[m] based on the individual designation signal Sd[m].

In the first embodiment, it is assumed that, during a unit period TP in which the printing processing is executed, the dispensing portion D[m] is capable of forming any of the following dots: a large dot made of ink with an ink amount ξ1, a medium dot made of ink with an ink amount ξ2 that is less than the ink amount ξ1, or a small dot made of ink with an ink amount ξ3 that is less than the ink amount ξ2.

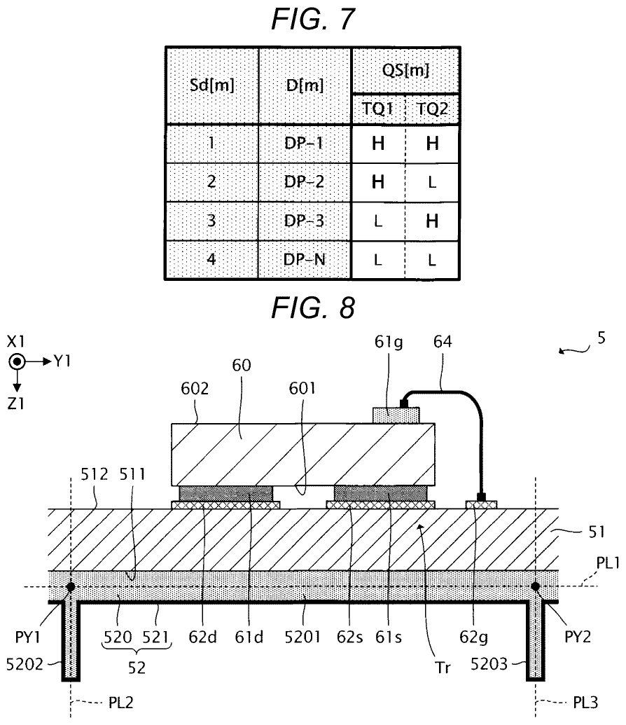

FIG. 7 is a diagram for illustrating an example of the individual designation signal Sd[m].

As shown in FIG. 7, in the first embodiment, the individual designation signal Sd[m] can take any one of four values during the unit period TP in which the printing processing is executed: a value of “1” that designates the dispensing portion D[m] as a large dot forming dispensing portion DP-1; a value of “2” that designates the dispensing portion D[m] as a medium dot forming dispensing portion DP-2; a value of “3” that designates the dispensing portion D[m] as a small dot forming dispensing portion DP-3; and a value of “4” that designates the dispensing portion D[m] as a non-dot forming dispensing portion DP-N.

Here, the large dot forming dispensing portion DP-1 is the dispensing portion D that forms a large dot in the unit period TP. The medium dot forming dispensing portion DP-2 is the dispensing portion D that forms a medium dot in the unit period TP. The small dot forming dispensing portion DP-3 is the dispensing portion D that forms a small dot in the unit period TP. The non-dot forming dispensing portion DP-N is the dispensing portion D that does not form a dot in the unit period TP.

The description returns to FIG. 6.

As shown in FIG. 6, in the first embodiment, the drive signal Com has a waveform PA1 provided in the driving period TQ1 and a waveform PA2 provided in the driving period TQ2.

The waveform PAL is a waveform goes from a potential V0 to a potential VLA1 that is lower than the potential V0, and a potential VHA1 that is higher than the potential V0, before returning to the potential V0. When the supply drive signal Vin[m] having the waveform PA1 is supplied to the dispensing portion D[m], the waveform PA1 is determined such that the ink corresponding to an ink amount φ1 is dispensed from the dispensing portion D[m]. The waveform PA2 is a waveform that goes from the potential V0 to a potential VLA2 that is lower than the potential V0, and a potential VHA2 that is higher than the potential V0, before returning to the potential V0. When the supply drive signal Vin[m] having the waveform PA2 is supplied to the dispensing portion D[m], the waveform PA2 is determined such that the ink corresponding to an ink amount φ2 is dispensed from the dispensing portion D[m]. In the first embodiment, it is assumed that the ink amount ξ1 corresponds to a sum of the ink amount φ1 and the ink amount φ2, the ink amount ξ2 corresponds to the ink amount φ1, and the ink amount ξ3 corresponds to the ink amount φ2.

In the first embodiment, as an example, it is assumed that, when the potential of the supply drive signal Vin[m] supplied to the dispensing portion D[m] is a high potential, a volume of the cavity CV provided in the dispensing portion D[m] is smaller than that when the potential is a low potential. Therefore, when the dispensing portion D[m] is driven by the supply drive signal Vin[m] having the waveform PA1 and the like, the potential of the supply drive signal Vin[m] changes from the low potential to the high potential, and thus the ink in the dispensing portion D[m] is dispensed from the nozzle N.

As shown in FIG. 7, when the individual designation signal Sd[m] indicates the value “1” that designates the dispensing portion D[m] as the large dot forming dispensing portion DP-1 in the unit period TP, the coupling state designation circuit 310 sets the coupling state designation signal QS[m] to a high level in the driving period TQ1 and the driving period TQ2. In this case, the switch WS[m] is turned on during the driving period TQ1 and the driving period TQ2. Therefore, the dispensing portion D[m] is driven by the supply drive signal Vin[m] having the waveform PA1 and the waveform PA2 in the unit period TP, and dispensed the ink of the ink amount ξ1 corresponding to the large dot.

In addition, when the individual designation signal Sd[m] indicates the value “2” that designates the dispensing portion D[m] as the medium dot forming dispensing portion DP-2 in the unit period TP, the coupling state designation circuit 310 sets the coupling state designation signal QS[m] to a high level in the driving period TQ1. In this case, the switch WS[m] is turned on in the driving period TQ1. Therefore, the dispensing portion D[m] is driven by the supply drive signal Vin[m] having the waveform PA1 in the unit period TP, and dispenses the ink of the ink amount ξ2 corresponding to the medium dot.

In addition, when the individual designation signal Sd[m] indicates the value “3” that designates the dispensing portion D[m] as the small dot forming dispensing portion DP-3 in the unit period TP, the coupling state designation circuit 310 sets the coupling state designation signal QS[m] to a high level in the driving period TQ2. In this case, the switch WS[m] is turned on in the driving period TQ2. Therefore, the dispensing portion D[m] is driven by the supply drive signal Vin[m] having the waveform PA2 in the unit period TP, and dispenses the ink of the ink amount ξ3 corresponding to the small dot.

When the individual designation signal Sd[m] indicates the value “4” that designates the dispensing portion D[m] as the non-dot forming dispensing portion DP-N in the unit period TP, the coupling state designation circuit 310 sets the coupling state designation signal QS[m] to the low level over the unit period TP. In this case, the switch WS[m] is turned off for the unit period TP. Therefore, the dispensing portion D[m] is not driven by the supply drive signal Vin[m] in the unit period TP, and does not dispense the ink.

### A.4. Configuration of Drive Signal Generation Unit 5

Hereinafter, the configuration of the drive signal generation unit 5 will be described with reference to FIG. 8.

FIG. 8 is a cross-sectional view showing an example of the configuration of the drive signal generation unit 5 in a case in which the drive signal generation unit 5 is cut by a plane which is a plane having the X-axis direction as a normal direction and intersects with the transistor Tr. In the first embodiment, as an example, it is assumed that the transistor Tr1 and the transistor Tr2 have the same structure.

As shown n FIG. 8, the transistor Tr is provided on a substrate 51 in the drive signal generation unit 5. Specifically, in the first embodiment, it is assumed that the substrate 51 is a flat plate-shaped member extending having the Z-axis direction as a normal direction, and has two surfaces having the Z-axis direction as a normal direction, a surface 511 facing the Z1 direction, and a surface 512 facing the Z2 direction. Further, in the first embodiment, it is assumed that the transistor Tr is provided on the surface 512 of the substrate 51.

The transistor Tr includes a chip body portion 60, a gate electrode 61g, a source electrode 61s, and a drain electrode 61d.

The chip body portion 60 is a part that is so-called a die, and has, for example, a substantially rectangular parallelepiped shape. In the first embodiment, it is assumed that the chip body portion 60 has a surface 601 facing the Z1 direction and a surface 602 facing the Z2 direction with two surfaces having the Z-axis direction as the normal direction.

In the first embodiment, as an example, it is assumed that the source electrode 61s and the drain electrode 61d are provided on the surface 601 of the chip body portion 60, and the gate electrode 61g is provided on the surface 602.

A plurality of gate coupling terminals 62g are provided on the surface 512 of the substrate 51 to correspond to the plurality of transistors Tr in the drive signal generation unit 5. The gate electrode 61g is electrically coupled to the gate coupling terminal 62g provided corresponding to the transistor Tr including the gate electrode 61g. In the first embodiment, as an example, it is assumed that the gate electrode 61g is electrically coupled to the gate coupling terminal 62g via a wire 64.

Each gate coupling terminal 62g is electrically coupled to the integrated circuit 40. Specifically, the gate coupling terminal 62g provided corresponding to the transistor Tr1 is electrically coupled to the terminal TnG1 of the integrated circuit 40 via the resistor RG1. The gate coupling terminal 62g provided corresponding to the transistor Tr2 is electrically coupled to the terminal TnG2 of the integrated circuit 40 via the resistor RG2.

A plurality of source coupling terminals 62s are provided on the surface 512 of the substrate 51 to correspond to the plurality of transistors Tr in the drive signal generation unit 5. The source electrode 61s is electrically coupled to the source coupling terminal 62s provided corresponding to the transistor Tr including the source electrode 61s. In the first embodiment, as an example, it is assumed that the source electrode 61s is directly coupled to the source coupling terminal 62s.

Each source coupling terminal 62s is electrically coupled to the node Nd or a power supply line set to the reference potential VLL. Specifically, the source coupling terminal 62s provided corresponding to the transistor Tr1 is electrically coupled to the node Nd. The source coupling terminal 62s provided corresponding to the transistor Tr2 is electrically coupled to the power supply line set to the reference potential VLL.

A plurality of drain coupling terminals 62d are provided on the surface 512 of the substrate 51 to correspond to the plurality of transistors Tr in the drive signal generation unit 5. The drain electrode 61d is electrically coupled to the drain coupling terminal 62d provided corresponding to the transistor Tr including the drain electrode 61d. In the first embodiment, as an example, it is assumed that the drain electrode 61d is directly coupled to the drain coupling terminal 62d.

Each of the drain coupling terminals 62d is electrically coupled to the node Nd or the power supply line set to the power supply potential VHH. Specifically, the drain coupling terminal 62d provided corresponding to the transistor Tr1 is electrically coupled to the power supply line set to the power supply potential VHH. The drain coupling terminal 62d provided corresponding to the transistor Tr2 is electrically coupled to the node Nd.

A heat sink 52 is attached to the surface 511 of the substrate 51. The heat sink 52 includes a main body portion 520 and a coating portion 521.

The main body portion 520 is made of copper or aluminum, and includes a base portion 5201, a fin 5202, and a fin 5203.

The base portion 5201 extends on a plane PL1 having the Z-axis direction as the normal direction. The fin 5202 is coupled to a coupling portion PY1 of the base portion 5201 and extends on a plane PL2 having the Y-axis direction as the normal direction. The fin 5203 is coupled to a coupling portion PY2 of the base portion 5201 located in the Y1 direction when viewed from the coupling portion PY1, and extends on a plane PL3 having the Y-axis direction as the normal direction. That is, in the first embodiment, the heat sink 52 includes two fins.

In the first embodiment, the base portion 5201 is an example of a “first plate-shaped portion”, the fin 5202 is an example of a “second plate-shaped portion”, the fin 5203 is an example of a “third plate-shaped portion”, the plane PL1 is an example of a “first plane”, the plane PL2 is an example of a “second plane”, the plane PL3 is an example of a “third plane”, the coupling portion PY1 is an example of a “first part”, and the coupling portion PY2 is an example of a “second part”.

The coating portion 521 is made of graphene and coats the main body portion 520. Specifically, the coating portion 521 coats at least all of surfaces of the fins 5202 and 5203 of the main body portion 520 and the surface of the base portion 5201 in the Z1 direction.

Here, graphene is a sheet-shaped substance made of carbon atoms. Hereinafter, a sheet-shaped substance having a thickness of one carbon atom in graphene is referred to as a graphene sheet. In the first embodiment, it is assumed that the coating portion 521 is made up of a plurality of layers of graphene sheets.

### A.5. Example in Related Art

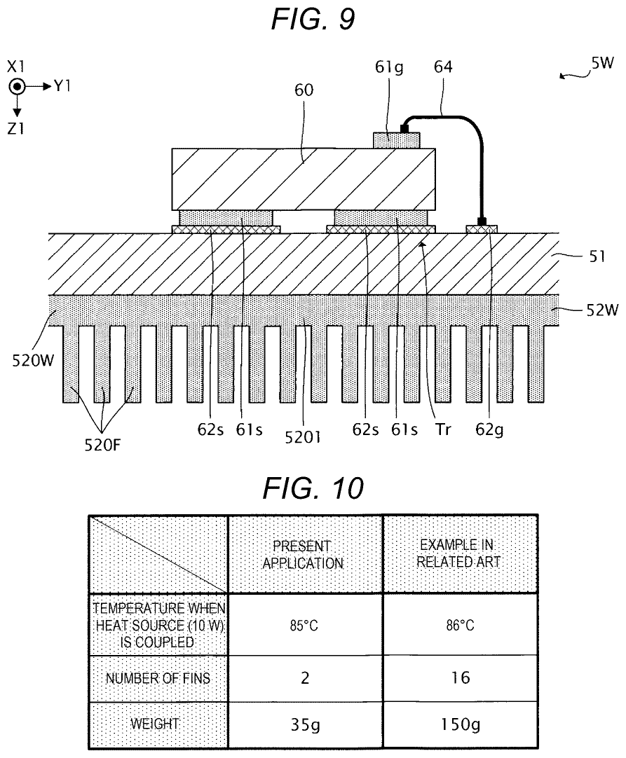

Hereinafter, effects of the drive signal generation unit 5 according to the first embodiment will be described after the drive signal generation unit 5W according to the example in the related art is described with reference to FIGS. 9 and 10.

FIG. 9 is a cross-sectional view showing an example of the configuration of the drive signal generation unit 5W in a case in which the drive signal generation unit 5W is cut by a plane which is a plane having the X-axis direction as a normal direction and intersects with the transistor Tr.

As shown in FIG. 9, the drive signal generation unit 5W has a configuration same as that of the drive signal generation unit 5 according to the first embodiment except that a heat sink 52W is provided instead of the heat sink 52. The heat sink 52W is different from the heat sink 52 according to the first embodiment in that the heat sink 52W includes a main body portion 520W instead of the main body portion 520 and does not include the coating portion 521. Similarly to the main body portion 520, the main body portion 520W is formed of copper or aluminum. The main body portion 520W is formed similarly to the main body portion 520 according to the first embodiment except that three or more fins 520F are provided instead of the fin 5202 and the fin 5203. Specifically, the main body portion 520W includes ten or more fins 520F. Each of the fins 520F is a flat plate-shaped member extending so that the Z-axis direction is the normal direction.

FIG. 10 is a diagram showing actual measurement results of temperatures of the drive signal generation unit 5 and the drive signal generation unit 5W and actual measurement results of weights of the heat sink 52 and the heat sink 52W.

As shown in FIG. 10, when the drive signal generation unit 5 according to the first embodiment has a heat source of 10W, the temperature of the drive signal generation unit 5 including the heat sink 52 is “85° C.”. On the other hand, when the drive signal generation unit 5W according to the example in the related art has a heat source of 10W, the temperature of the drive signal generation unit 5W including the heat sink 52W is “86° C.”. In this way, the temperature of the drive signal generation unit 5 including the heat sink 52 and the temperature of the drive signal generation unit 5W including the heat sink 52W are substantially the same. Here, “substantially the same” includes, in addition to a case of being completely the same, a case of being regarded as being the same in consideration of an error, for example, a case of being the same in design but having a manufacturing error and thus being different from each other, and a case of being the same in specification but having an error due to disturbance and thus being different from each other. In the first embodiment, it is assumed that “substantially the same” is a concept including a case in which an error of about 10% is considered to be the same.

As shown in FIG. 10, the number of fins of the heat sink 52 according to the first embodiment is “2” and the weight thereof is “35 g”. On the other hand, the number of fins of the heat sink 52W according to the example in the related art is “16” and the weight thereof is “150 g”.

In this way, since the heat sink 52 according to the first embodiment has the number of fins limited to two, a significant weight reduction is achieved compared to the heat sink 52W having ten or more fins. Specifically, the weight of the heat sink 52 according to the first embodiment can be reduced to about 25% as compared with the heat sink 52W according to the example in the related art. Therefore, according to the first embodiment, when the drive signal generation unit 5 is mounted on the carriage 110 and the drive signal generation unit 5 is moved, it is possible to reduce a load on the carriage conveyance motor 91 that drives the carriage 110, compared to the case in which the drive signal generation unit 5W according to the example in the related art is mounted on the carriage 110 and the drive signal generation unit 5W is moved. That is, the drive signal generation unit 5 according to the first embodiment enables the carriage conveyance motor 91 to have a longer life and reduces an amount of power related to driving of the carriage conveyance motor 91, compared to a configuration in which the drive signal generation unit 5W according to the example in the related art is mounted on the carriage 110.

In addition, since the surface of the heat sink 52 according to the first embodiment is coated with graphene, the heat sink 52 according to the first embodiment has excellent heat dissipation properties as compared with the heat sink 52W according to the example in the related art which is not coated with graphene. Therefore, the heat sink 52 according to the first embodiment can maintain the temperature of the drive signal generation unit 5 at a temperature same as that of the drive signal generation unit 5W provided with the heat sink 52, although the number of fins is significantly smaller than that of the heat sink 52W according to the example in the related art. In other words, the heat sink 52 according to the first embodiment makes it easier to achieve both weight reduction and improvement in heat dissipation properties compared to the heat sink 52W according to the example in the related art.

In addition, since the surface of the heat sink 52 according to the first embodiment is coated with graphene, it is possible to reduce the possibility that the heat sink 52 is corroded by mist of ink as compared with the heat sink 52W according to the example in the related art which is not coated with graphene. Therefore, the heat sink 52 according to the first embodiment can prevent a decrease in heat dissipation performance due to corrosion of the heat sink 52 as compared with the heat sink 52W according to the example in the related art, and can maintain high heat dissipation performance over a long period.

### B. Second Embodiment

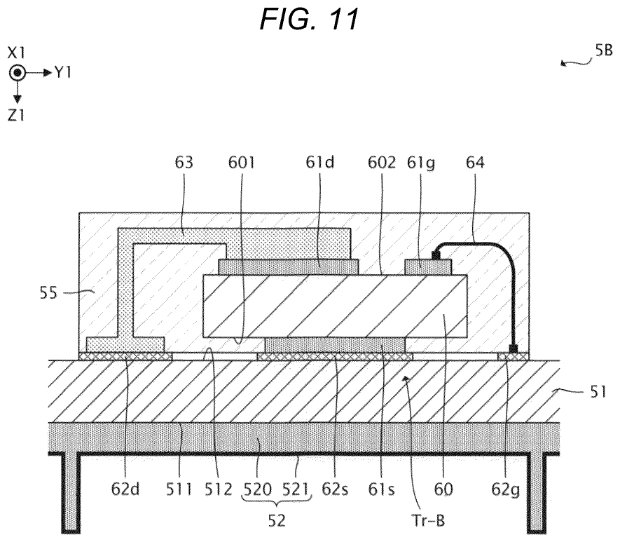

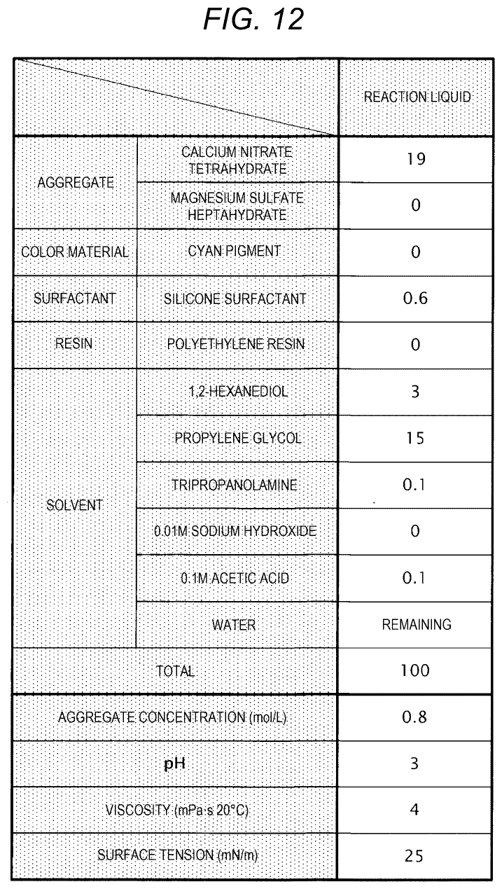

Hereinafter, the inkjet printer 1 according to a second embodiment will be described with reference to FIGS. 11 and 12. In each embodiment shown below, the reference numerals used in the description of the first embodiment are used for elements having the same effects and functions as those of the first embodiment, and a detailed description thereof will be omitted as appropriate.

FIG. 11 is a cross-sectional view showing an example of the configuration of the drive signal generation unit 5B provided in the inkjet printer 1 according to the second embodiment. Specifically, FIG. 11 is a cross-sectional view showing an example of a configuration of the drive signal generation unit 5B in a case in which the drive signal generation unit 5B is cut by a plane having the X-axis direction as a normal direction and intersects with a transistor Tr-B. The inkjet printer 1 according to the second embodiment is implemented in the same manner as the inkjet printer 1 according to the first embodiment except that the drive signal generation unit 5B is provided instead of the drive signal generation unit 5. In the second embodiment, the transistor Tr1 and the transistor Tr2 shown in FIG. 4 are collectively referred to as the transistor Tr-B.

As shown in FIG. 11, the drive signal generation unit 5B is implemented similarly to the drive signal generation unit 5 according to the first embodiment except that the transistor Tr-B is provided instead of the transistor Tr, a mold member 55 is provided, and a clip 63 is provided.

The transistor Tr-B is implemented similarly to the transistor Tr according to the first embodiment except that the source electrode 61s is provided on the surface 601 and the gate electrode 61g and the drain electrode 61d are provided on the surface 602 in the chip body portion 60.

A plurality of gate coupling terminals 62g are provided on the surface 512 of the substrate 51 to correspond to the plurality of transistors Tr-B in the drive signal generation unit 5B. The gate electrode 61g is electrically coupled to the gate coupling terminal 62g provided corresponding to the transistor Tr-B including the gate electrode 61g. In the second embodiment, as an example, it is assumed that the gate electrode 61g is electrically coupled to the gate coupling terminal 62g via a wire 64.

A plurality of source coupling terminals 62s are provided on the surface 512 of the substrate 51 to correspond to the plurality of transistors Tr-B in the drive signal generation unit 5B. The source electrode 61s is electrically coupled to the source coupling terminal 62s provided corresponding to the transistor Tr-B including the source electrode 61s. In the second embodiment, as an example, it is assumed that the source electrode 61s is directly coupled to the source coupling terminal 62s.

A plurality of drain coupling terminals 62d are provided on the surface 512 of the substrate 51 to correspond to the plurality of transistors Tr-B in the drive signal generation unit 5B. The drain electrode 61d is electrically coupled to the drain coupling terminal 62d provided corresponding to the transistor Tr-B including the drain electrode 61d. In the second embodiment, as an example, it is assumed that the drain electrode 61d is electrically coupled to the drain coupling terminal 62d via the clip 63.

Here, the clip 63 is a component formed of a metal such as copper. That is, in the second embodiment, it is assumed that the transistor Tr-B (that is, the transistor Tr1 and transistor Tr2) has a Cu clip structure.

The mold member 55 is formed of an insulating material such as resin. The mold member 55 is provided on the surface 512 of the substrate 51 to seal the transistor Tr-B. In the second embodiment, as an example, it is assumed that the mold member 55 is provided on the surface 512 of the substrate 51 to cover the transistor Tr-B, the clip 63, and the wire 64.

In the second embodiment, it is assumed that a reaction liquid can be dispensed from a part of the plurality of dispensing portions D provided in the liquid dispensing unit 3. Here, the reaction liquid is a liquid for fixing the ink to the recording paper PP. In the second embodiment, the inkjet printer 1 dispenses the ink onto the recording paper PP from one dispensing portion D in the liquid dispensing unit 3, and then dispenses the reaction liquid onto the recording paper PP from another dispensing portion D in the liquid dispensing unit 3, thereby fixing the ink attached to the recording paper PP to the recording paper PP. In the second embodiment, the reaction liquid is another example of the “liquid”.

FIG. 12 is a diagram showing an example of a composition and physical properties of the reaction liquid according to the second embodiment.

As shown in FIG. 12, the reaction liquid contains calcium nitrate tetrahydrate as a flocculant at a ratio of 19 mass %, and contains a silicon-based surfactant as a surfactant at a ratio of 0.6 mass %. The reaction liquid contains, as a solvent, 1,2-hexanediol at a ratio of 3 mass %, propylene glycol at a ratio of 15 mass %, tripropanolamine at a ratio of 0.1 mass %, and 0.1 M acetic acid at a ratio of 0.1 mass %, with water as a remaining composition so that a total mass is 100 mass %. Further, the reaction liquid is adjusted so that a flocculant concentration is 0.8 (mol/L), a pH is “3”, a viscosity is 4 (mPa·s ° C.), and a surface tension is 25 (mN/m).

A liquid having a pH of “3 or less” may be used as the reaction liquid. As the reaction liquid, a “reaction liquid H7” disclosed by the present applicant in JP-A-2016-199001 may be used.

As described above, in the second embodiment, the transistor Tr-B has a Cu clip structure. Therefore, in the second embodiment, it is possible to increase areas of the drain electrode 61d and the drain coupling terminal 62d, and the source electrode 61s and the source coupling terminal 62s, compared to a mode in which the Cu clip structure is not employed. Accordingly, in the second embodiment, it is possible to secure high heat dissipation properties from the transistor Tr-B compared to a mode in which the Cu clip structure is not employed.

In the second embodiment, since the transistor Tr-B employs the Cu clip structure, it is possible to enhance an impact resistance of the transistor Tr-B compared to a mode in which the drain electrode 61d and the drain coupling terminal 62d are coupled by the wire 64 without employing the Cu clip structure. Accordingly, in the second embodiment, even in a case in which there is a high possibility that an impact is applied to the drive signal generation unit 5B such as a case in which the drive signal generation unit 5B including the transistor Tr-B is mounted on the carriage 110, it is possible to achieve a longer life for the drive signal generation unit 5B as compared with a mode in which the Cu clip structure is not adopted.

In the second embodiment, the liquid dispensing unit 3 dispenses the reaction liquid having the pH of 3 or less. Further, if a low pH liquid, that is, a pH of 3 or less, adheres to a metal inside the inkjet printer 1, there is a high possibility that the metal is corroded. In contrast, in the second embodiment, since the transistor Tr-B is covered with the mold member 55, adhesion of the ink and the reaction liquid to the transistor Tr-B can be reduced as compared with a mode in which the drive signal generation unit 5B does not include the mold member 55. Therefore, according to the second embodiment, as compared with the mode in which the drive signal generation unit 5B does not include the mold member 55, corrosion of the metal such as the wiring and the terminal of the transistor Tr-B is prevented, and a longer life for the transistor Tr-B can be achieved.

In the second embodiment, a mode in which the transistor Tr-B is provided with the source electrode 61s on the surface 601 and the gate electrode 61g and the drain electrode 61d on the surface 602 of the chip body portion 60 is described as an example, and the present disclosure is not limited to such a mode. For example, the transistor Tr-B may have the drain electrode 61d provided on the surface 601 of the chip body portion 60, and the gate electrode 61g and the source electrode 61s provided on the surface 602. In this case, the drain electrode 61d may be directly coupled to the drain coupling terminal 62d. In this case, the source electrode 61s may be electrically coupled to the source coupling terminal 62s via the clip 63. In this case, the gate electrode 61g may be electrically coupled to the gate coupling terminal 62g via the wire 64.

In the second embodiment, a mode in which the gate electrode 61g is electrically coupled to the gate coupling terminal 62g via the wire 64 is described as an example, and the present disclosure is not limited thereto. For example, the gate electrode 61g may be electrically coupled to the gate coupling terminal 62g via a conductive clip such as the clip 63.

### C. Third Embodiment

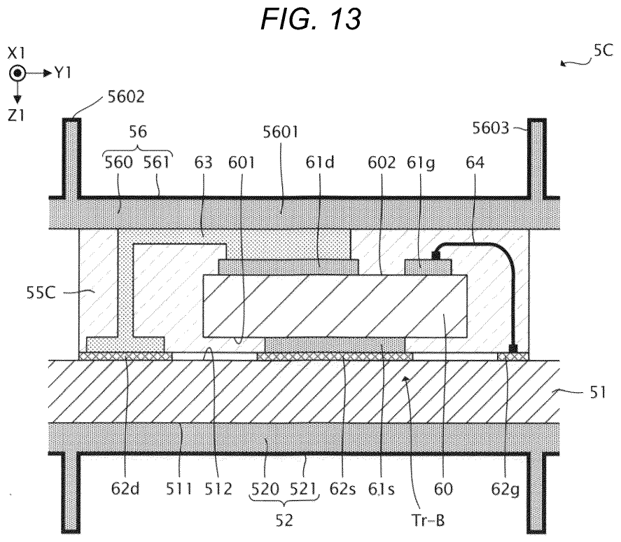

Hereinafter, the inkjet printer 1 according to a third embodiment will be described with reference to FIG. 13. In each embodiment shown below, the reference numerals used in the description of the first embodiment and the second embodiment are used for elements having the same effects and functions as those of the first embodiment and the second embodiment, and a detailed description thereof will be omitted as appropriate.

FIG. 13 is a cross-sectional view showing an example of the configuration of the drive signal generation unit 5C provided in the inkjet printer 1 according to the third embodiment. Specifically, FIG. 13 is a cross-sectional view showing an example of a configuration of the drive signal generation unit 5C in a case in which the drive signal generation unit 5C is cut by a plane having the X-axis direction as a normal direction and intersects with the transistor Tr-B. The inkjet printer 1 according to the third embodiment is implemented in the same manner as the inkjet printer 1 according to the second embodiment except that the drive signal generation unit 5C is provided instead of the drive signal generation unit 5. In the third embodiment, similarly to the second embodiment, the transistor Tr1 and the transistor Tr2 shown in FIG. 4 are collectively referred to as the transistor Tr-B.

As shown in FIG. 13, the drive signal generation unit 5C is implemented similarly to the drive signal generation unit 5B according to the second embodiment except that a mold member 55C is provided instead of the mold member 55, and a heat sink 56 is provided.

As described above, the transistor Tr-B has the source electrode 61s provided on the surface 601 of the chip body portion 60, and the gate electrode 61g and the drain electrode 61d provided on the surface 602. The gate electrode 61g is electrically coupled to the gate coupling terminal 62g via the wire 64. The source electrode 61s is directly coupled to the source coupling terminal 62s. The drain electrode 61d is electrically coupled to the drain coupling terminal 62d via the clip 63. That is, in the third embodiment, similarly to the second embodiment, it is assumed that the transistor Tr-B (that is, the transistor Tr1 and the transistor Tr2) has a Cu clip structure.

The mold member 55C is formed of an insulating material such as resin. The mold member 55C is provided on the surface 512 of the substrate 51 to seal the transistor Tr-B. In the second embodiment, as an example, it is assumed that the mold member 55 is provided on the surface 512 of the substrate 51 to cover the transistor Tr-B and the wire 64 and expose the surface of the clip 63 in the Z2 direction.

The heat sink 56 is provided over the surface of the clip 63 in the Z2 direction and the surface of the mold member 55C in the Z2 direction. The heat sink 56 includes a main body portion 560 and a coating portion 561.

The main body portion 560 is formed of copper or aluminum, and includes a base portion 5601 extending in a flat plate shape having the Z-axis direction as a normal direction, a fin 5602 extending in a flat plate shape having the Y-axis direction as a normal direction, and a fin 5603 extending in a flat plate shape having the Y-axis direction as a normal direction. That is, in the third embodiment, the heat sink 56 includes two fins similarly to the heat sink 52.

The coating portion 561 is made of graphene and coats the main body portion 560. Specifically, the coating portion 561 coats at least all of surfaces of the fins 5602 and 5603 of the main body portion 560 and the surface of the base portion 5601 in the Z2 direction. In the third embodiment, it is assumed that the coating portion 561 is made up of a plurality of layers of graphene sheets.

As described above, according to the third embodiment, since the drive signal generation unit 5C includes the heat sink 56, it is possible to dissipate heat in the Z2 direction from the heat sink 56 in addition to dissipating heat in the Z1 direction from the heat sink 52. Therefore, according to the third embodiment, it is possible to secure high heat dissipation properties in the drive signal generation unit 5C as compared with a mode in which heat dissipation in the Z2 direction is not assumed.

In addition, according to the third embodiment, since the transistor Tr-B is covered with the mold member 55C, adhesion of the ink and the reaction liquid to the transistor Tr-B can be reduced as compared with a mode in which the drive signal generation unit 5C does not include the mold member 55C. Therefore, according to the third embodiment, as compared with the mode in which the drive signal generation unit 5C does not include the mold member 55C, corrosion of the metal such as the wiring and the terminal of the transistor Tr-B is prevented, and a longer life for the transistor Tr-B can be achieved. In the third embodiment, similarly to the second embodiment, the liquid dispensing unit 3 may dispense the reaction liquid having the pH of 3 or less.

According to the third embodiment, since the transistor Tr-B has the Cu clip structure, it is possible to increase areas of the drain electrode 61d and the drain coupling terminal 62d, and the source electrode 61s and the source coupling terminal 62s, compared to a mode in which the Cu clip structure is not employed. Accordingly, in the third embodiment, it is possible to secure high heat dissipation properties from the transistor Tr-B compared to a mode in which the Cu clip structure is not employed.

The surface of the heat sink 56 according to the third embodiment is coated with graphene, and therefore can exhibit excellent performance in terms of weight reduction, heat dissipation properties, and corrosion resistance, compared to the mode in which the heat sink 52W according to the example in the related art, which is not coated with graphene, is used as the heat sink 56.

In the third embodiment, a mode in which the transistor Tr-B is provided with the source electrode 61s on the surface 601 and the gate electrode 61g and the drain electrode 61d on the surface 602 of the chip body portion 60 is described as an example, and the present disclosure is not limited to such a mode. For example, the transistor Tr-B may have the drain electrode 61d provided on the surface 601 of the chip body portion 60, and the gate electrode 61g and the source electrode 61s provided on the surface 602. In this case, the drain electrode 61d may be directly coupled to the drain coupling terminal 62d. In this case, the source electrode 61s may be electrically coupled to the source coupling terminal 62s via the clip 63. In this case, the gate electrode 61g may be electrically coupled to the gate coupling terminal 62g via the wire 64.

In the third embodiment, a mode in which the gate electrode 61g is electrically coupled to the gate coupling terminal 62g via the wire 64 is described as an example, and the present disclosure is not limited thereto. For example, the gate electrode 61g may be electrically coupled to the gate coupling terminal 62g via a conductive clip such as the clip 63.

In the third embodiment, a mode in which the drive signal generation unit 5C includes the heat sink 52 and the heat sink 56 coated with graphene is described as an example, and the present disclosure is not limited to the mode. The drive signal generation unit 5C may include the heat sink 52W instead of the heat sink 52 on the surface 511 of the substrate 51, or may include the heat sink 52W instead of the heat sink 56 on the surfaces of the clip 63 and the mold member 55C in the Z2 direction.

### D. Modifications

The above-described embodiments can be variously modified. Specific modifications are shown below. Two or more configurations freely selected from the following illustrations can be combined as appropriate as long as the configurations are mutually consistent. In the modifications illustrated below, elements having the same effects and functions as those of the embodiments have the same reference signs as used in the above description, and the detailed description thereof will be omitted as appropriate.

### D.1. Modification 1

In the first to third embodiments described above, the case in which the drive signal generation unit 5 and the liquid dispensing unit 3 are separate bodies is described as an example, and the present disclosure is not limited to such a mode. The drive signal generation unit 5 may be incorporated in the liquid dispensing unit 3.

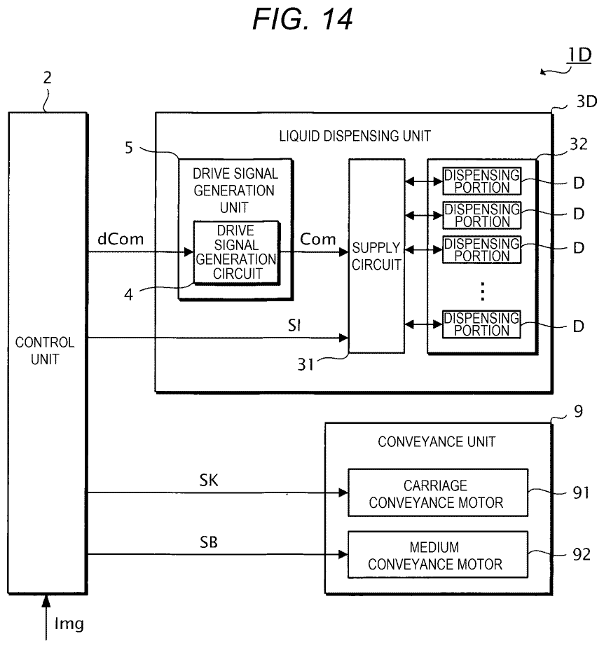

FIG. 14 is a functional block diagram showing an example of a configuration of an inkjet printer 1D according to Modification 1.

As shown in FIG. 14, the inkjet printer 1D has a configuration same as the inkjet printer 1 according to the first embodiment except that the liquid dispensing unit 3D is provided instead of the liquid dispensing unit 3. The liquid dispensing unit 3D has a configuration same as the liquid dispensing unit 3 according to the first embodiment except that the liquid dispensing unit 3D includes the drive signal generation unit 5. FIG. 14 shows a mode in which the liquid dispensing unit 3D includes the drive signal generation unit 5 as an example, and the present disclosure is not limited to such a mode. The liquid dispensing unit 3D may include the drive signal generation unit 5B instead of the drive signal generation unit 5, or may include the drive signal generation unit 5C instead of the drive signal generation unit 5.

### D.2. Modification 2

In the first embodiment to the third embodiment and Modification 1 described above, the mode in which the mold member 55 or the mold member 55C seals one transistor Tr or one transistor Tr-B is described as an example, and the present disclosure is not limited to such a mode. The mold member 55 or the mold member 55C may seal two or more transistors Tr or two or more transistors Tr-B.

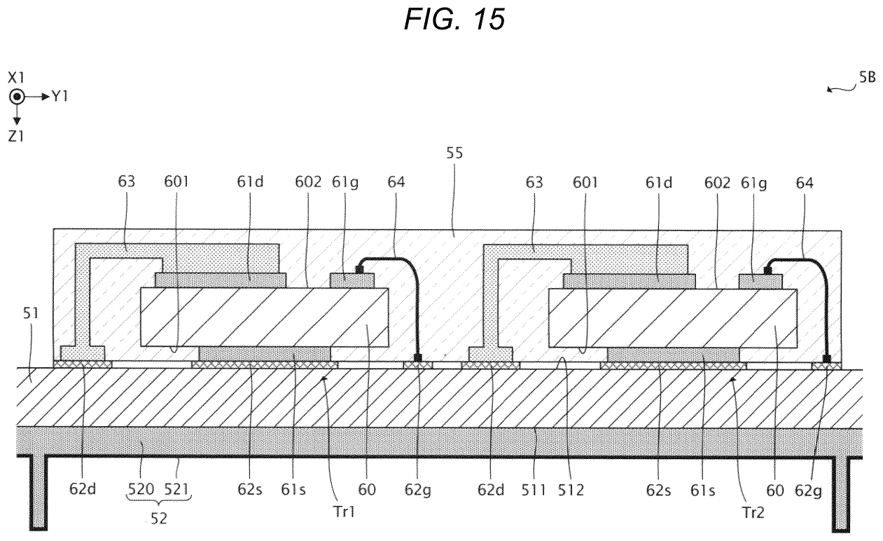

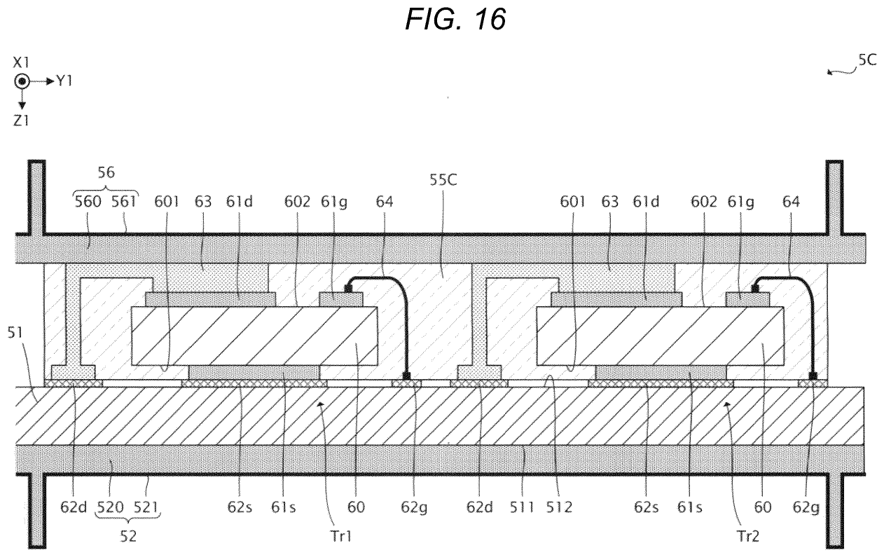

For example, as shown in FIG. 15, the mold member 55 may seal the transistor Tr1 and the transistor Tr2 as one package. For example, as shown in FIG. 16, the mold member 55C may seal the transistor Tr1 and the transistor Tr2 as one package.

### D.3. Modification 3

In the first to third embodiments and Modifications 1 and 2 described above, it is assumed that the inkjet printer 1 includes four liquid dispensing units 3 and four drive signal generation units 5, and the present disclosure is not limited to such a mode. The inkjet printer 1 may include one or more and three or less liquid dispensing units 3 and one or more and three or less drive signal generation units 5, or may include five or more liquid dispensing units 3 and five or more drive signal generation units 5.

### E. Appendices

Modes related to the above description will be described below with appendices. In order to facilitate understanding of each mode, reference numerals in the drawings are added in parentheses for convenience in the following description, and the present disclosure is not limited to the shown modes.

### E.1. Appendix 1

The inkjet printer 1 according to Appendix 1 will be described below.

### Appendix 1-1

The inkjet printer 1 according to Appendix 1-1 includes: the liquid dispensing unit 3 including a plurality of piezoelectric elements PZ[m] driven by a drive signal Com and for dispensing an ink in response to driving of the plurality of piezoelectric elements PZ[m]; and the drive signal generation unit 5 configured to generate the drive signal Com. The drive signal generation unit 5 includes the substrate 51, the drive signal generation circuit 4 disposed on the substrate 51 and configured to generate the drive signal Com, and the heat sink 52 fixed to the substrate 51. The heat sink 52 includes the main body portion 520 formed of copper or aluminum, and the main body portion 520 is coated with graphene.

According to Appendix 1-1, since the heat sink 52 is coated with graphene, it is possible to enhance the heat dissipation properties of the heat sink 52 as compared with a mode in which the heat sink 52 is not coated with graphene. In addition, according to Appendix 1-1, since the heat sink 52 is coated with graphene, it is possible to reduce the possibility that the main body portion 520 in the heat sink 52 is corroded, and it is possible to prevent a decrease in the heat dissipation properties of the heat sink 52 due to the corrosion of the heat sink 52, as compared with the mode in which the heat sink 52 is not coated with graphene.

### Appendix 1-2

The inkjet printer 1 according to Appendix 1-2 is based on the inkjet printer 1 according to Appendix 1-1, in which a part of the ink dispensed from the liquid dispensing unit 3 is turned into mist.

According to Appendix 1-2, since the heat sink 52 is coated with graphene, it is possible to reduce the possibility that the main body portion 520 in the heat sink 52 is corroded by mist, as compared with the mode in which the heat sink 52 is not coated with graphene.

### Appendix 1-3

The inkjet printer 1 according to Appendix 1-3 is based on the inkjet printer 1 according to Appendix 1-1 or 1-2, in which the main body portion 520 is coated with multiple layers of graphene.

According to Appendix 1-3, since the heat sink 52 is coated with multiple layers of graphene, it is possible to reduce the possibility that the main body portion 520 in the heat sink 52 is corroded by mist, as compared with a mode in which the heat sink 52 is not coated with a single layer of graphene.

### Appendix 1-4

The inkjet printer 1 according to Appendix 1-4 is based on the inkjet printer 1 according to Appendices 1-1 to 1-3, in which the main body portion 520 includes the base portion 5201 extending on the plane PL1 having the Z1 direction as a normal direction, the fin 5202 coupled to the coupling portion PY1 of the base portion 5201 and extending on the plane PL2 having the Y1 direction intersecting the Z1 direction as the normal direction, and the fin 5203 coupled to the coupling portion PY2 of the base portion 5201 and extending on the plane PL3 having the Y1 direction as the normal direction.

In Appendix 1, the Z1 direction is an example of a “first direction”, and the Y1 direction is an example of a “second direction”.

In Appendices 1 to 4, since the heat sink 52 has a simple shape having two fins of the fin 5202 and the fin 5203, it is possible to reduce a weight of the heat sink 52 as compared with the heat sink 52W having a large number of fins. In addition, in Appendices 1 to 4, since the heat sink 52 is coated with graphene, it is possible to secure high heat dissipation properties in the heat sink 52. That is, according to Appendices 1 to 4, it is possible to achieve both weight reduction of the heat sink 52 and securing high heat dissipation properties in the heat sink 52.

### Appendix 1-5

The inkjet printer 1 according to Appendix 1-5 is based on the inkjet printer 1 according to Appendices 1-1 to 1-4, which includes the carriage 110 on which the liquid dispensing unit 3 and the drive signal generation unit 5 are mounted and which is configured to move on the recording paper PP on which the ink is dispensed from the liquid dispensing unit 3, and the carriage conveyance motor 91 for moving the carriage 110, and the liquid dispensing unit 3 dispenses the ink while the carriage 110 is moving.

According to Appendix 1-5, since the drive signal generation unit 5 including the heat sink 52 is mounted on the carriage 110, it is possible to reduce a load applied to the carriage conveyance motor 91 as compared with a mode in which the drive signal generation unit 5W including the heat sink 52W is mounted.

### E.2. Appendix 2

The inkjet printer 1 according to Appendix 2 will be described below.

### Appendix 2-1

The inkjet printer 1 according to Appendix 2-1 includes: the liquid dispensing unit 3 which includes a piezoelectric element PZ[m] driven by a drive signal Com and dispenses an ink in response to driving of the piezoelectric element PZ[m], and the drive signal generation unit 5B which generates the drive signal Com. The drive signal generation unit 5B includes the integrated circuit 40 which generates a gate signal SG1 and a gate signal SG2, a transistor Tr1 to which the gate signal SG1 is input, a transistor Tr2 to which the gate signal SG2 is input, an inductor L0 which has one end electrically coupled to the transistor Tr1 and the transistor Tr2 and the other end electrically coupled to an output terminal In-out which outputs the drive signal Com, the substrate 51 on which the integrated circuit 40, the transistor Tr1, the transistor Tr2, and the inductor L0 are mounted, and the mold member 55 which covers the transistor Tr1 on the substrate 51, and the transistor Tr1 has a Cu clip structure.

According to Appendix 2-1, since the transistor Tr1 has the Cu clip structure, the transistor Tr1 can dissipate heat from a side opposite to the substrate 51 in addition to being able to dissipate heat from a substrate 51 side. Therefore, according to Appendix 2-1, it is possible to enhance the heat dissipation properties of the transistor Tr1 as compared with a mode in which the transistor Tr1 does not have a Cu clip structure, and it is possible to prevent the transistor Tr1 from reaching a high temperature. In addition, according to Appendix 2-1, since the drive signal generation unit 5B includes the mold member 55 that covers the transistor Tr1, it is possible to reduce the possibility of a failure of the transistor Tr1 due to adhesion of the ink to the transistor Tr1, compared to a mode in which the mold member 55 is not provided.

### Appendix 2-2

The inkjet printer 1 according to Appendix 2-2 is based on the inkjet printer 1 according to Appendix 2-1, in which a pH of the liquid dispensed from the liquid dispensing unit 3 is 3 or less.

According to Appendix 2-2, since the drive signal generation unit 5B includes the mold member 55 that covers the transistor Tr1, it is possible to reduce the possibility of corrosion of the transistor Tr1 even in a situation in which a liquid having a pH of 3 or less is dispensed from the liquid dispensing unit 3 and metal corrosion easily occurs in the inkjet printer 1.

### Appendix 2-3

The inkjet printer 1 according to Appendix 2-3 is based on the inkjet printer 1 according to Appendix 2-1 or 2-2, and includes the carriage 110 on which the liquid dispensing unit 3 and the drive signal generation unit 5B are mounted and which is configured to move on the recording paper PP on which the ink is dispensed from the liquid dispensing unit 3, and the carriage conveyance motor 91 for moving the carriage 110, and the liquid dispensing unit 3 dispenses the ink while the carriage 110 is moving.

According to Appendix 2-3, since the transistor Tr1 has the Cu clip structure, it is possible to enhance an impact resistance of the drive signal generation unit 5B including the transistor Tr1 compared to a mode in which the transistor Tr1 is coupled to the substrate 51 by a wire or the like. Accordingly, according to Appendix 2-3, even when the drive signal generation unit 5B including the transistor Tr1 is mounted on the carriage 110 and there is a high possibility that an impact is applied to the drive signal generation unit 5B, it is possible to achieve a longer life for the drive signal generation unit 5B.

### Appendix 2-4

The inkjet printer 1 according to Appendix 2-4 is based on the inkjet printer 1 according to Appendices 2-1 to 2-3, in which the transistor Tr1 includes the chip body portion 60, the drain electrode 61d provided on the surface 601 facing the substrate 51 among a plurality of surfaces of the chip body portion 60, and the source electrode 61s provided on the surface 602 opposite to the surface 601 among the plurality of surfaces of the chip body portion 60, the drain electrode 61d is coupled to the drain coupling terminal 62d provided on the substrate 51, the source electrode 61s is coupled to the conductive clip 63, and the clip 63 is coupled to the source coupling terminal 62s provided on the substrate 51.

In Appendix 2, the surface 601 is an example of a “first surface”, and the surface 602 is an example of a “second surface”.

According to Appendix 2-4, since the heat generated in the source electrode 61s and the drain electrode 61d, which generate a large amount of heat, of the transistor Tr1 is dissipated from the two surfaces of the surface 601 and the surface 602 of the chip body portion 60, it is possible to enhance the heat dissipation properties of the transistor Tr1 as compared with a mode in which the heat is dissipated from a single surface of the chip body portion 60.

### Appendix 2-5

The inkjet printer 1 according to Appendix 2-5 is based on the inkjet printer 1 according to Appendices 2-1 to 2-3, in which the transistor Tr1 includes the chip body portion 60, the source electrode 61s provided on the surface 601 facing the substrate 51 among a plurality of surfaces of the chip body portion 60, and the drain electrode 61d provided on the surface 602 opposite to the surface 601 among the plurality of surfaces of the chip body portion 60, the source electrode 61s is coupled to the source coupling terminal 62s provided on the substrate 51, the drain electrode 61d is coupled to the conductive clip 63, and the clip 63 is coupled to the drain coupling terminal 62d provided on the substrate 51.

According to Appendices 2-5, since the heat generated in the source electrode 61s and the drain electrode 61d, which generate a large amount of heat, of the transistor Tr1 is dissipated from the two surfaces of the surface 601 and the surface 602 of the chip body portion 60, it is possible to enhance the heat dissipation properties of the transistor Tr1 as compared with a mode in which the heat is dissipated from a single surface of the chip body portion 60.

### Appendix 2-6

The inkjet printer 1 according to Appendix 2-6 is based on the inkjet printer 1 according to Appendices 2-1 to 2-5, in which the gate signal SG1 is a signal for designating ON or OFF of the transistor Tr1, and has a frequency of 1 MHz or higher and 8 MHz or lower.

According to Appendix 2-6, it is possible to improve accuracy of the waveform of the drive signal Com generated in the drive signal generation unit 5B including the transistor Tr1 and to reduce switching loss in the transistor Tr1.

### Appendix 2-7

The inkjet printer 1 according to Appendix 2-7 is based on the inkjet printer 1 according to Appendices 2-1 to 2-6, in which the mold member 55 covers the transistor Tr1 and the transistor Tr2 on the substrate 51.

According to Appendix 2-7, since two transistors Tr, the transistor Tr1 and the transistor Tr2, are formed into one package, it is possible to reduce component constants and mounting areas of the transistor Tr1 and the transistor Tr2, as compared to a mode in which the transistor Tr1 and the transistor Tr2 are separate. Therefore, according to Appendix 2-7, the drive signal generation unit 5B can be made smaller and lighter.

### E.3. Appendix 3

The inkjet printer 1 according to Appendix 3 will be described below.

### Appendix 3-1

The inkjet printer 1 according to Appendix 3-1 includes: the liquid dispensing unit 3 which includes a piezoelectric element PZ[m] driven by a drive signal Com and dispenses an ink in response to driving of the piezoelectric element PZ[m], and the drive signal generation unit 5C which generates the drive signal Com. The drive signal generation unit 5C includes the integrated circuit 40 which generates a gate signal SG1 and a gate signal SG2, a transistor Tr1 to which the gate signal SG1 is input, a transistor Tr2 to which the gate signal SG2 is input, an inductor L0 which has one end electrically coupled to the transistor Tr1 and the transistor Tr2 and the other end electrically coupled to an output terminal Tn-out which outputs the drive signal Com, the substrate 51 on which the integrated circuit 40, the transistor Tr1, the transistor Tr2, and the inductor L0 are mounted, and the heat sink 56 that is provided on an opposite side of the substrate 51 as viewed from the transistor Tr1 and that dissipates heat from the surface 602 that is on the opposite side from the substrate 51 among a plurality of surfaces of the chip body portion 60 of the transistor Tr1.

In Appendix 3, the surface 602 is an example of a “first surface”, and the heat sink 56 is an example of a “first heat sink”.

According to Appendix 3-1, since the drive signal generation unit 5C includes the heat sink 56, the transistor Tr1 can dissipate heat from a side opposite to the substrate 51 in addition to being able to dissipate heat from a substrate 51 side. Therefore, according to Appendix 3-1, it is possible to enhance the heat dissipation properties of the transistor Tr1 as compared which a mode in which the drive signal generation unit 5C does not include the heat sink 56, and it is possible to prevent the transistor Tr1 from reaching a high temperature.

### Appendix 3-2

The inkjet printer 1 according to Appendix 3-2 is based on the inkjet printer 1 according to Appendix 3-1, which includes the mold member 55 that covers the transistor Tr1 on the substrate 51, and a pH of the liquid dispensed from the liquid dispensing unit 3 is 3 or less.

According to Appendix 3-2, since the drive signal generation unit 5C includes the mold member 55 that covers the transistor Tr1, it is possible to reduce the possibility of corrosion of the transistor Tr1 even in a situation in which a liquid having a pH of 3 or less is dispensed from the liquid dispensing unit 3 and metal corrosion easily occurs in the inkjet printer 1.

### Appendix 3-3

The inkjet printer 1 according to Appendix 3-3 is based on the inkjet printer 1 according to Appendix 3-1 or 3-2, and includes the carriage 110 on which the liquid dispensing unit 3 and the drive signal generation unit 5C are mounted and which is configured to move on the recording paper PP on which the ink is dispensed from the liquid dispensing unit 3, and the carriage conveyance motor 91 for moving the carriage 110, and the liquid dispensing unit 3 dispenses the ink while the carriage 110 is moving.

According to Appendix 3-3, since the drive signal generation unit 5C is mounted on the carriage 110 and moves, it is possible to dissipate the heat from the heat sink 56 more efficiently than in a mode in which the drive signal generation unit 5C is not mounted on the carriage 110.

### Appendix 3-4

The inkjet printer 1 according to Appendix 3-4 is based on the inkjet printer 1 according to Appendices 3-1 to 3-3, in which the transistor Tr1 has a Cu clip structure.

According to Appendix 3-4, it is possible to enhance the heat dissipation properties of the transistor Tr1 as compared with a mode in which the transistor Tr1 does not have a Cu clip structure, and it is possible to prevent the transistor Tr1 from reaching a high temperature.

### Appendix 3-5

The inkjet printer 1 according to Appendix 3-5 is based on the inkjet printer 1 according to Appendices 3-1 to 3-4. The transistor Tr1 includes the chip body portion 60, the source electrode 61s provided on the surface 602 among a plurality of surfaces of the chip body portion 60, and the drain electrode 61d provided on the surface 601 opposite to the surface 602 among the plurality of surfaces of the chip body portion 60, the drain electrode 61d is coupled to the drain coupling terminal 62d provided on the substrate 51, the source electrode 61s is coupled to the conductive clip 63, and the clip 63 is coupled to the source coupling terminal 62s provided on the substrate 51.

In Appendix 3, the surface 601 is an example of a “second surface”.

According to Appendix 3-5, since the heat generated in the source electrode 61s and the drain electrode 61d, which generate a large amount of heat, of the transistor Tr1 is dissipated from the two surfaces of the surface 601 and the surface 602 of the chip body portion 60, it is possible to enhance the heat dissipation properties of the transistor Tr1 as compared with a mode in which the heat is dissipated from a single surface of the chip body portion 60.

### Appendix 3-6

The inkjet printer 1 according to Appendix 3-6 is based on the inkjet printer 1 according to Appendices 3-1 to 3-5, in which the transistor Tr1 includes the chip body portion 60, the drain electrode 61d provided on the surface 602 among a plurality of surfaces of the chip body portion 60, and the source electrode 61s provided on the surface 601 opposite to the surface 602 among the plurality of surfaces of the chip body portion 60, the source electrode 61s is coupled to the source coupling terminal 62s provided on the substrate 51, the drain electrode 61d is coupled to the conductive clip 63, and the clip 63 is coupled to the drain coupling terminal 62d provided on the substrate 51.

According to Appendix 3-6, since the heat generated in the source electrode 61s and the drain electrode 61d, which generate a large amount of heat, of the transistor Tr1 is dissipated from the two surfaces of the surface 601 and the surface 602 of the chip body portion 60, it is possible to enhance the heat dissipation properties of the transistor Tr1 as compared with a mode in which the heat is dissipated from a single surface of the chip body portion 60.

### Appendix 3-7

The inkjet printer 1 according to Appendix 3-7 is based on the inkjet printer 1 according to Appendices 3-1 to 3-6, in which the heat sink 56 includes the main body portion 560 formed of copper or aluminum, and the main body portion 560 is coated with graphene.

According to Appendix 3-7, since the heat sink 56 is coated with graphene, it is possible to enhance the heat dissipation properties of the heat sink 56 as compared with a mode in which the heat sink 56 is not coated with graphene. In addition, according to Appendix 3-7, since the heat sink 56 is coated with graphene, it is possible to reduce the possibility that the main body portion 560 in the heat sink 56 is corroded, and it is possible to prevent a decrease in the heat dissipation properties of the heat sink 56 due to the corrosion of the heat sink 56, as compared with the mode in which the heat sink 56 is not coated with graphene.

### Appendix 3-8

The inkjet printer 1 according to Appendix 3-8 is based on the inkjet printer 1 according to Appendices 3-1 to 3-7, in which the gate signal SG1 is a signal for designating ON or OFF of the transistor Tr1, and has a frequency of 1 MHz or higher and 8 MHz or lower.

According to Appendix 3-8, it is possible to improve accuracy of the waveform of the drive signal Com generated in the drive signal generation unit 5C including the transistor Tr1 and to reduce switching loss in the transistor Tr1.

### Appendix 3-9

The inkjet printer 1 according to Appendix 3-9 is based on the inkjet printer 1 according to Appendices 3-1 to 3-8, which includes the mold member 55 that covers the transistors Tr1 and Tr2 on the substrate 51.

According to Appendix 3-9, since two transistors Tr, the transistor Tr1 and the transistor Tr2, are formed into one package, it is possible to reduce component constants and mounting areas of the transistor Tr1 and the transistor Tr2, as compared to a mode in which the transistor Tr1 and the transistor Tr2 are separate.

### Appendix 3-10

The inkjet printer 1 according to Appendix 3-10 is based on the inkjet printer 1 according to Appendices 3-1 to 3-9, which includes the heat sink 52 fixed to the substrate 51.

In Appendix 3, the heat sink 52 is an example of a “second heat sink”.

According to Appendix 3-10, since heat dissipation is possible through the heat sink 56 and through the heat sink 52, it is possible to improve heat dissipation efficiency in the drive signal generation unit 5C compared to a mode in which the heat sink 52 is not provided.

What is claimed is:

1. A liquid dispensing unit including a plurality of driving elements driven by a drive signal and for dispensing a liquid in response to driving of the plurality of driving elements, the liquid dispensing unit comprising:
a substrate;
a drive signal generation circuit disposed on the substrate and configured to generate the drive signal; and
a heat sink fixed to the substrate, wherein
the heat sink includes a main body portion formed of copper or aluminum, and
the main body portion is coated with graphene.

2. The liquid dispensing unit according to claim 1, wherein
a part of the liquid dispensed from the liquid dispensing unit is turned into mist.

3. The liquid dispensing unit according to claim 1, wherein
the main body portion is coated with multiple layers of graphene.

4. The liquid dispensing unit according to claim 1, wherein
the main body portion includes
a first plate-shaped portion extending on a first plane having a first direction as a normal direction,
a second plate-shaped portion coupled to a first part of the first plate-shaped portion and extending on a second plane having a second direction intersecting the first direction as the normal direction, and
a third plate-shaped portion coupled to a second part of the first plate-shaped portion which is different from the first part and extending on a third plane having the second direction as the normal direction.

5. The liquid dispensing unit according to claim 1, wherein
the liquid dispensing unit is mounted on a carriage that moves over a medium onto which the liquid is dispensed from the liquid dispensing unit, and dispenses the liquid when the carriage is moved by a motor for moving the carriage.

6. A liquid dispensing device comprising:
a liquid dispensing unit including a plurality of driving elements driven by a drive signal and for dispensing a liquid in response to driving of the plurality of driving elements; and
a drive signal generation unit configured to generate the drive signal, wherein
the drive signal generation unit includes
a substrate,
a drive signal generation circuit disposed on the substrate and configured to generate the drive signal, and
a heat sink fixed to the substrate,
the heat sink includes a main body portion formed of copper or aluminum, and
the main body portion is coated with graphene.

7. The liquid dispensing device according to claim 6, wherein
a part of the liquid dispensed from the liquid dispensing unit is turned into mist.

8. The liquid dispensing device according to claim 6, wherein
the main body portion is coated with multiple layers of graphene.

9. The liquid dispensing device according to claim 6, wherein
the main body portion includes
a first plate-shaped portion extending on a first plane having a first direction as a normal direction,
a second plate-shaped portion coupled to a first part of the first plate-shaped portion and extending on a second plane having a second direction intersecting the first direction as the normal direction, and
a third plate-shaped portion coupled to a second part of the first plate-shaped portion which is different from the first part and extending on a third plane having the second direction as the normal direction.

10. The liquid dispensing device according to claim 6, further comprising:
a carriage on which the liquid dispensing unit and the drive signal generation unit are mounted and which is configured to move on a medium onto which the liquid is dispensed from the liquid dispensing unit; and
a motor for moving the carriage, wherein
the liquid dispensing unit dispenses the liquid while the carriage is moving.
